(19) United States
(12) Patent Application Publication
(10) Pub. No.: US 2018/0107832 A1
(43) Pub. Date: Apr. 19, 2018

(54) TABLE PRIVILEGE MANAGEMENT

(71) Applicant: SAP SE, Walldorf (DE)

(72) Inventors: Frank Ouyang, Xi'an (CN); Jian Wang, Xi'an (CN); Zhen Tian, Xi'an (CN)

(21) Appl. No.: 15/294,297

(22) Filed: Oct. 14, 2016

(51) Int. Cl. G06F 21/62; G06F 17/30

(52) U.S. Cl. CPC G06F 21/6218; G06F 17/30289

(57) ABSTRACT

Various examples are directed to systems and methods for table privilege management. A database management system (DBMS) may receive a first client request describing a first database operation on a first record from a first table of a database. The DBMS may determine that a user associated with the first client request lacks privileges to perform the first database operation on record fields in a first column of the table. The DBMS may generate a modified first database operation that does not perform the first operation on a first record field of the first record that is in the first column and may execute the modified first database operation at the database.

### TECHNICAL FIELD

This document generally relates to methods and systems for use with computer networks. More particularly, this document relates to table privilege management.

### BACKGROUND

Databases are used in many different computer processing environments to store data, often in a structured and easily-accessible way. Many databases are managed by database management systems that execute database operations received from users. Database operations may include, for example, structured query language (SQL) operations such as SELECT, UPDATE, DELETE, INSERT, etc. In many database management systems, user privileges are granted on a table level. For example, when a database management system allows a user to request database operations on a table, the user may be enabled to request database operations that act on and/or return any rows or columns of the table.

### BRIEF DESCRIPTION OF DRAWINGS

The present disclosure is illustrated by way of example and not limitation in the following figures.

FIG. 1 is a diagram showing one example of an environment for implementing table privilege management.

FIG. 2 is a diagram illustrating an example of in-memory database management system that may be used to implement table privilege management, for example, as described herein.

FIG. 3 is a diagram illustrating an example of an index server of the in-memory database management system of FIG. 2.

FIG. 4 is a diagram illustrating one example of the request processing and execution control of the database management system of FIG. 2.

FIG. 5 is a flow chart showing one example of a process flow that may be executed by a database management system to process a client request.

FIG. 6 is a flowchart showing one example of a process flow that may be executed by a database management system to set or change a user privilege with respect to a row and/or column.

FIG. 7 is a block diagram showing one example of a software architecture for a computing device.

FIG. 8 is a block diagram of a machine in the example form of a computer system within which instructions may be executed for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

There are many situations where it is desirable to grant a user access to some, but not all, of a database table. In one example, a bank or other financial institution may use a database table (e.g., a customer deposit table) that records customer deposits. Columns of the table may represent the customers' names, account numbers, deposit amounts, etc. Rows of the table may represent individual deposits. In this example, the customer deposit table may include records (or rows) for customers of the bank, including VIP customers, who may wish to keep their banking activities discreet. Accordingly, it may be desirable for the bank to limit access to the customer deposit table by row such that senior clerks have access to records indicating VIP customer deposits, while more junior clerks have access only to records indicating non-VIP customers,

In another example, a human resources department may utilize a database table to store employee data (e.g., an employee data table). The employee data table may have columns representing employee names, addresses, salaries, etc. Rows of the table may represent individual employees. In this example, it may be desirable to allow general human resources employees to view or edit records at columns corresponding to general employee information such as, for example, address, dependents, etc. On the other hand, it may also be desirable to limit the human resources employees who are able to view or edit employee records at columns corresponding to salary or other sensitive information. In some examples, other privilege conditions may be desirable. For example, a junior HR user may be permitted to modify a rows or columns relating to employees with salaries less than a salary threshold.

As described above, many database management systems handle user privileges at the table level. In the bank example above, then, the database management system may allow a user to be granted (or not granted) privileges to perform operations with respect to the entire customer deposit table. The inventors have recognized that this deficiency could be overcome by using database views. A database view, or simply a view, is a stored query, for example, according to Structured Query Language (SQL) or another suitable language. A view may return less than all of the rows or columns in a table. Views may be updatable, which allows user to modify the columns and/or rows returned by a view. Using views to manage user privileges, however, can be complex and difficult. For example, each combination of a user and a database operation may require a distinct view to be stored in a manner that is accessible to the database management system.

Various examples described herein are directed to a database management system that utilizes a privilege filter and privilege table to implement user privileges at the column and/or row level. The privilege table may include privilege table records indicating users as well as the users' privileges with respect to one or more table columns and/or rows. For example, a user may have privileges to access a particular row or column, to perform particular database operations that act on a particular row or column, etc. User privileges may also be conditioned. For example, a user may be permitted to read and/or write record fields in a particular column only when another record field in the same record or row has a value falling into a particular range. E.g., referring to the human resources example above, the junior user may be permitted to change an employee's title (at a record field in a first column) but only if the employee's salary (at a record field in a second column) is less than a salary threshold.

The database management system may receive a client request from a user that indicates a database operation to be performed at a database table. The database management system may query the privilege table to determine whether the user has privileges to perform the requested database operations on all of the columns and/or rows to be read, written, etc. If not, a privilege filter of the DMBS may deny the customer request. If the requested database operation includes both operations that are permitted and operations that are not permitted, then the privilege filter may generate a modified database operation that only acts on the rows and/or columns matching the privileges of the user. Referring back to the bank example above, then, if a junior clerk requests a database operation that would return records that include a record corresponding to a VW customer deposit, the privilege filter may determine that the junior clerk lacks privileges to act on VIP customer deposit records. The privilege filter may venerate and execute an alternative database operation that does not return VIP customer deposit records, but does return other records responsive to the junior clerk's request.

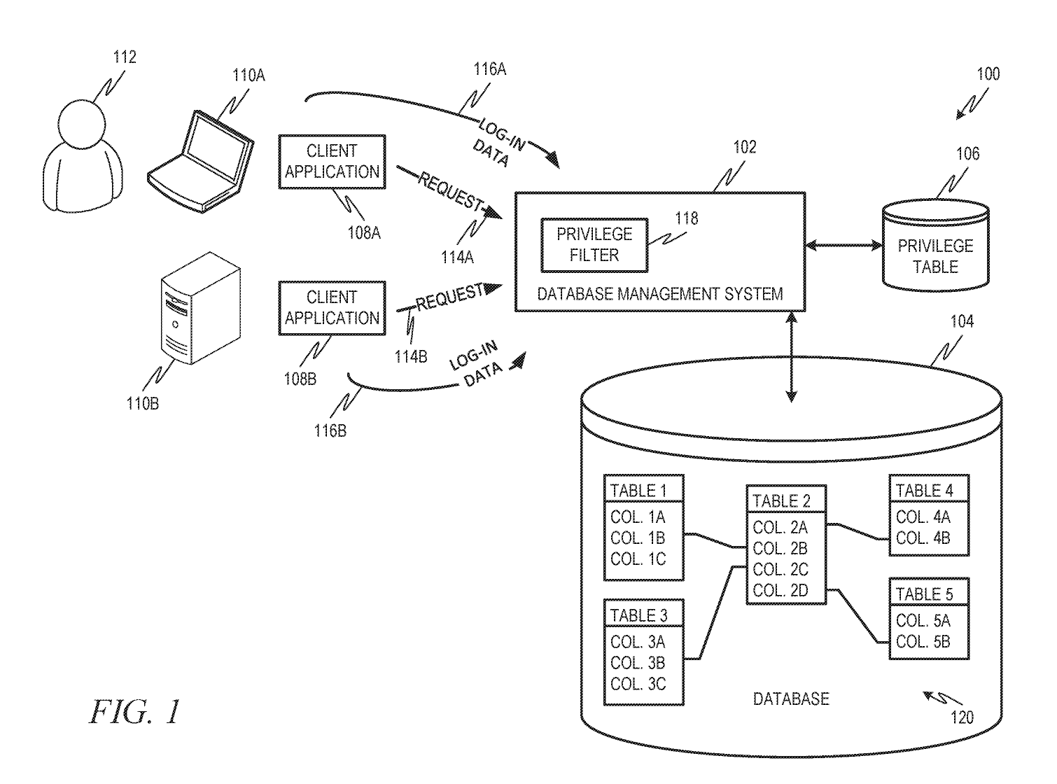

FIG. 1 is a diagram showing one example of an environment 100 for implementing table privilege management. The environment 100 includes a. database management system 102 with a privilege filter 118. The database management system 102 is in communication with client applications 108A, 108B, which may execute at client computing devices 110A, 110B.

The database management system 102 manages a database 104 organized according to an example database schema 120. A database schema, such as the database schema 120, may describe various tables at a database including the columns of the tables and the relationships between the tables. The example database schema 120 shown in FIG. 1 includes five tables, labeled TABLE 1, TABLE 2, TABLE 3. TABLE 4 and TABLE 5. Each table includes one or more columns. For example, TABLE 1 includes three columns labeled 1A, 1B, 1C. TABLE 2 includes four columns labeled 2A, 2B, 2C, 2D. TABLE 3 includes three columns labeled 3A, 3B, 3C. TABLE 4 includes two columns labeled 4A, 4B. TABLE 5 also includes two columns labeled 5A, 5B.

A table, such as TABLES 1-5 in the example database schema 120, may include one or more records. A record in a table may correspond to a row of the table. The record may include record fields that correspond to the columns of the table. For example, a representation of TABLE 1 of the example database schema 120 is provided below:

TABLE 1

| COL. 1A | COL. 1B | COL. 1C |
|---|---|---|
| (Empl. No.) | (Empl. Name) | (Empl. Salary) |
| 1 | SMITH | 3482 |
| 2 | JONES | 8367 |
| 3 | MCFLY | 2684 |

In the example above, COL. 1A may indicate an employee number; COL. 1B may indicate an employee name; and COL. 1C may indicate an employee salary. Three records are shown. A first record (1. SMITH, 3482) corresponds to a first row of TABLE 1 and includes three record fields. For example, a record field including the data “1” is classified under the column COL. 1A. (It may also be said that the record field including the data “1” is in the column COL. 1A.) A record field including the data “SMITH” is in the column COL. 1B. A record field including the data “3482” is in the column COL. 1C. The records (2, JONES, 8367) and (3, MCFLY, 2684) include record fields similarly described by the columns COL. 1A, COL. 1B, and COL. 1C.

The database schema 120 is an example provided to illustrate the systems and methods described herein. Table privilege management, in various examples, may be implemented in any suitable database schema, including schemas having more or fewer tables, tables with more or fewer columns, tables with more or fewer records, etc.

The client applications 108A, 108B may execute at client computing devices 110A, 110B. Client computing devices 110A, 110B may be or include any suitable computing device or combination of computing devices. For example, client computing devices 110A, 110B may be or include any suitable type of server, laptop computer, desktop computer, tablet computer, mobile computer, etc.

Client applications 108A, 108B may be associated with a user account or user. In some examples, the user is a human user. In FIG. 1, the example client application 108A is operated by a human user 112. In some examples, the user is non-human (e.g., a software or hardware component). For example, the client application 108B may have a user account with the database management system 102 that does not require human intervention to use. Accordingly, client application 108B may be a user. Client applications 108A, 108B may provide log-in data 116A, 116B to the database management system 102 to authenticate their associated user. Log-in data 116A, 116B may include a username, a password, and/or any suitable information for authenticating the user associated with the client application 108A, 108B. For example, when a client application, such as 108A is operated by a human user, such as the human user 112, the human user 112 may provide the log-in data 116A that is ultimately provided to the database management system 102. In examples where there is no human user (e.g., the client application 108B is the user), the client application 108B may store log-in data 116B at the client computing device 110B or another suitable location. In some examples, the client applications 108A, 108B provide log-in data 116A, 116B concurrent with client requests 114A, 114B. Also, in some examples, client applications 108A, 108B may provide log-in data 116A, 116B before providing client requests 114A, 114B, for example, by establishing a user session with the database management system 102. For example, client applications 108A, 108B may establish a user session with the database management system 102, for example, as described herein.

A client request 114A, 114B may describe one or more database operations to be performed by the database management system 102 on database 104. The database operations may be read and/or write operations. In some examples, the database operations may be or include Structured Query Language (SQL) operations such as, SELECT, UPDATE, DELETE, INSERT, etc. The database operations may act on all or a portion of the tables of the database schema 120.

Upon receiving a client request 114A, the privilege filter 118 may determine if the database operation or operations indicated in the client request 114A are consistent with the privileges of the user. For example, the privilege filter 118 may query a privilege table 106. The privilege table may be distinct form the database 104 and/or may be included in the database 104, for example, as part of the database schema 120. The privilege table 106 may include data describing user privileges. The privilege table 106 may indicate columns and/or rows of one or more tables at the database 104 that a user is permitted to act upon and in some examples may also indicate an operation or operations that the user is permitted to perform on the column and/or row and, optionally, a condition under which the user is permitted to perform one or more of the indicated actions. User privileges may be indicated positively or negatively. For example, the privilege table 106 may positive indicate columns and/or rows that a particular user is permitted to act upon. Also, in some examples, the privilege table 106 may negatively indicate columns and/or rows that a particular user is not permitted to act upon.

In some examples, the privilege table 106 may include privilege table records, where a privilege table record corresponds to a particular user and indicates rows and/or columns at the database 104 that the particular user is (or is not) permitted to act upon. When a user request is received from a particular user, the privilege filter 118 may query to the privilege table 106 to obtain the privilege table record corresponding to the particular user. The privilege table record may indicate whether the user is authorized to operate on rows and/or columns to be acted upon by the requested database operation.

If the user does have privileges to act upon all of the table rows and/or columns implicated by the requested database operation or operations, then the database management system 102 may proceed to execute the requested database operations and, in some cases, return results to the requesting user. If the user lacks privileges to any of the table rows and/or columns implicated by the requested database operation or operations, then the database management system 102 may reject the client request. If the user has privileges to perform the requested database operation or operations on some, but not all of the rows and/or columns implicated by the requested database operation or operations, then the privilege filter 118 may generate a modified database operation that does not act upon table rows and/or columns in a way that exceeds the user's privileges.

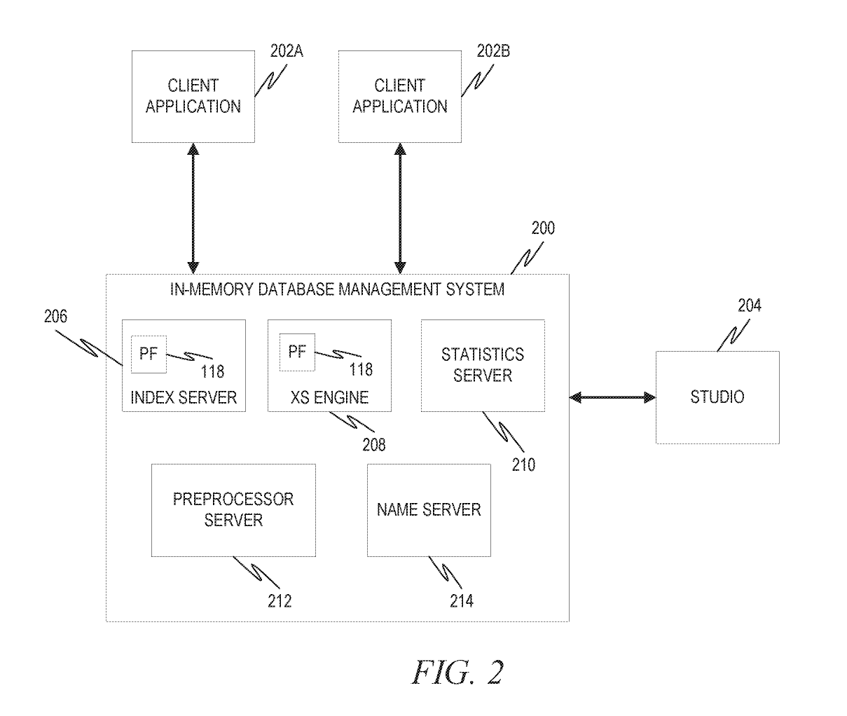

FIG. 2 is a diagram illustrating an example of an in-memory database management system 200 that may be used to implement table privilege management, for example, as described herein. An in-memory database stores data primarily at main memory, such as a random access memory (RAM). This is different than databases that primarily employ a disk storage mechanism. In some examples, the database management system 200 may be or include an example of the HANA system from SAP AG of Walldorf, Germany. Although various features of table privilege management are described herein in the context of an in-memory database, table privilege management may be generally performed at any suitable database management system.

The in-memory database management system 200 may be coupled to one or more client applications 202A, 202B. Client applications 202A, 202B may perform operations similar to those of the client applications 108A, 108B of FIG. 1. For example, the client applications 202A, 202B may perform one or more functions utilizing data from the database (e.g., database 104) including, for example, presenting a user interface (UI) to one or more users, etc. The client applications 202A, 202B may communicate with the in-memory database management system 200 through a number of different protocols, including Structured Query Language (SQL), Multidimensional Expressions (MDX), Hypertext Transfer Protocol (HTTP), Representational State Transfer (REST), Hypertext Markup Language (HTML).

FIG. 2 also shows a studio 204 that may be used to perform modeling by accessing the in-memory database management system 200. In some examples, the studio 204 may allow complex analysis to be performed on data drawn not only from real time event data and windows, but also from stored database information.

The in-memory database management system 200 may comprise a number of different components, including an index server 206, an XS engine 208, a statistics server 210, a preprocessor server 212, and a name server 214. These components may operate on a single computing device, or may be spread among multiple computing devices (e.g., separate servers). The index server 206 contains the actual data and the engines for processing the data. It may also coordinate and uses the other servers.

The XS engine 208 allows clients to connect to the in-memory database management system 200 using web protocols, such as Hypertext Transfer Protocol (HTTP). Although the XS engine 208 is illustrated as a component of the in-memory database management system 200, in some examples, the XS engine may be implemented as one or more Application Program Interfaces (APIs) and/or services positioned between the client applications 202A, 202B and the in-memory database management system 200. In some examples, the XS engine 208 may perform the functionality of the privilege filter 118. For example, the XS engine 208 may be configured to perform the functions of the privilege filter 118 for client requests received in languages other than SQL such as, for example, Multidimensional Expressions (MDX), Hypertext Transfer Protocol (HTTP), Representational State Transfer (REST), Hypertext Markup Language (HTML), etc.

The statistics server 210 collects information about status, performance, and resource consumption from all the other server components. The statistics server 210 can be accessed from the studio 204 to obtain the status of various alert monitors.

The preprocessor server 212 is used for analyzing text data and extracting the information on which the text search capabilities are based.

The name server 214 holds information about the database topology. This is used in a distributed system with instances of the database on different hosts. The name server 214 knows where the components are running and which data is located on which server. In an example embodiment, a separate enqueue server may operate in the manner described above with respect to enqueue servers, specifically with regard to creating and managing light-weight enqueue sessions.

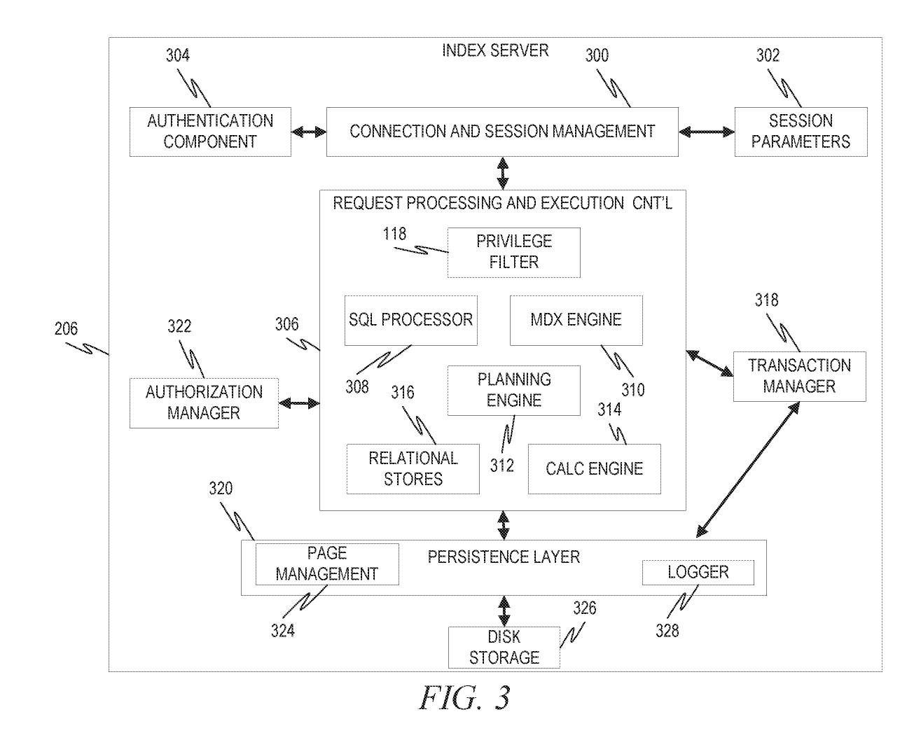

The index server 206, in some examples, may house an instance of the privilege filter 118. The instance of the privilege filter 118 at the index server 206 may be in addition to or instead of the instance of the privilege filter 118 at the XS engine 208. FIG. 3 is a diagram illustrating an example of the index server 206. Specifically, the index server 206 of FIG. 2 is depicted in more detail. The index server 206 includes a connection and session management component 300. which is responsible for creating and managing sessions and connections for the database clients (e.g. client applications 202A, 202B). Once a session is established, clients can communicate with the database system using SQL statements. For each session, a set of session parameters 302 may be maintained, such as auto-commit, current transaction isolation level, etc. Users (e.g., system administrators, developers) may be authenticated by the database system itself (e.g., by logging in with log-in information such as a user name and password, using an authentication component 304) or authentication can be delegated to an external authentication provider such as a Lightweight Directory Access Protocol (LDAP) directory.

Client requests can be analyzed and executed by a set of components summarized as request processing and execution control 306. An SQL processor 308 checks the syntax and semantics of the client SQL statements and generates a logical execution plan. Multidimensional expressions (MDX) is a language for querying and manipulating multidimensional data stored in OLAP cubes. As such, an MDX engine 310 may be provided to allow for the parsing and executing of MDX commands. A planning engine 312 allows applications to execute basic planning operations in the database layer. One such operation is to create a new version of a dataset as a copy of an existing dataset, while applying filters and transformations.

A calculation engine 314 implements the various SQL script and planning operations. The calculation engine 314 creates a logical execution plan for calculation models derived from SQL script, MDX, planning, and domain-specific models. This logical execution plan may include, for example, breaking up a model into operations that can be processed in parallel. The data is stored in relational stores 316, which implement a relational database in main memory. Each SQL statement may be processed in the context of a transaction. New sessions are implicitly assigned to a new transaction. A transaction manager 318 coordinates database transactions, controls transactional isolation, and keeps track of running and closed transactions. When a transaction is committed or rolled back, the transaction manager 318 informs the involved engines about this event so they can execute needed actions. The transaction manager 318 also cooperates with a persistence layer 320 to achieve atomic and durable transactions.

An authorization manager 322 is invoked by other database system components to check whether the user has the specified privileges to execute the requested operations. The database system allows for the granting of privileges to users or roles. A privilege grants the right to perform a specified operation on a specified object. For example, although the privilege filter 118 is illustrated as a separate component of the request processing and execution control component 306, in some examples, the functionality of the privilege filter 118 may be performed by the authorization manager 322.

The persistence layer 320 ensures that the database is restored to the most recent committed state after a restart and that transactions are either completely executed or completely undone. To achieve this goal in an efficient way, the persistence layer 320 uses a combination of write-ahead logs, shadow paging, and save points. The persistence layer 320 also offers a page management interface 324 for writing and reading data to a separate disk storage 326, and also contains a logger 328 that manages the transaction log. Log entries can be written implicitly by the persistence layer 320 when data is written via the persistence interface or explicitly by using a log interface.

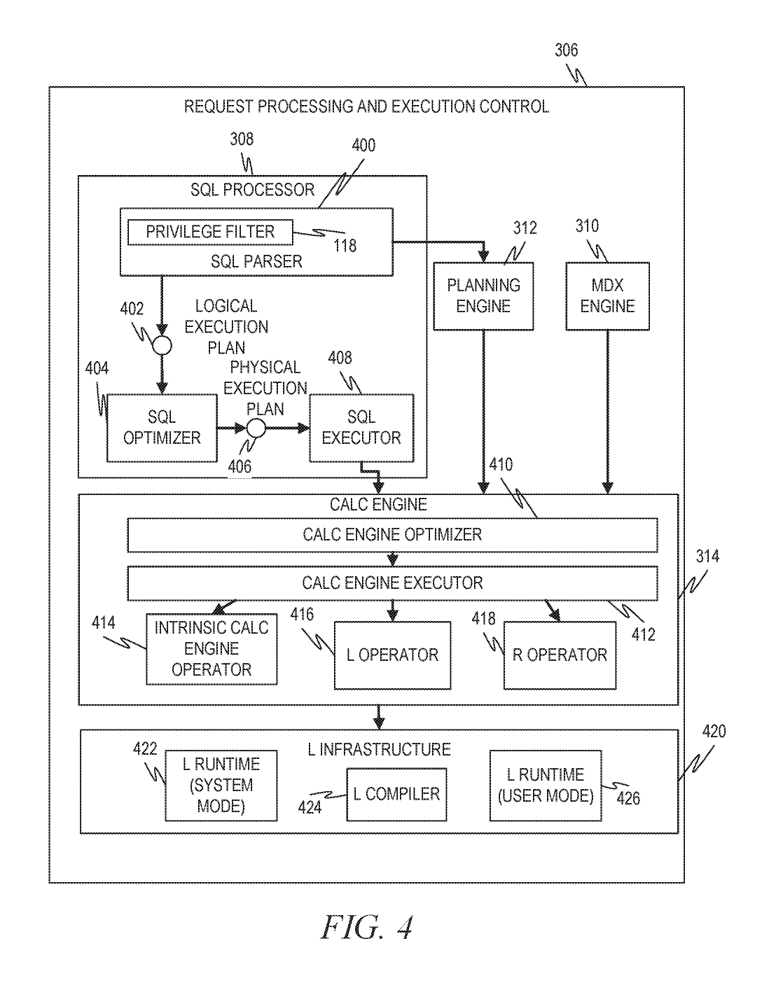

FIG. 4 is a diagram illustrating one example of the request processing and execution control 306. This diagram depicts the request processing and execution control 306 of FIG. 3 in more detail. The SQL processor 308 contains an SQL parser 400, which parses the SQL statement and generates a logical execution plan 402, which it passes to an SQL optimizer 404. In the example of FIG. 4, the privilege filter 118 is illustrated as a component of the SQL optimizer 404, although the privilege filter 118 may be implemented at any suitable position. The SQL optimizer 404 optimizes the logical execution plan 402 and converts it to a physical execution plan 406, which it then passes to a SQL executor 408. The calculation engine 314 implements the various SQL script and planning operations, and includes a calc engine optimizer 410, which optimizes the operations, and a calc engine executor 412, which executes the operations, as well as an intrinsic calc engine operator 414, an L operator 416, and an R operator 418.

An L infrastructure 420 includes a number of components to aid in the running of L procedures, including an L-runtime (system mode) 422, an L compiler 424, and an L-runtime (User mode) 426.

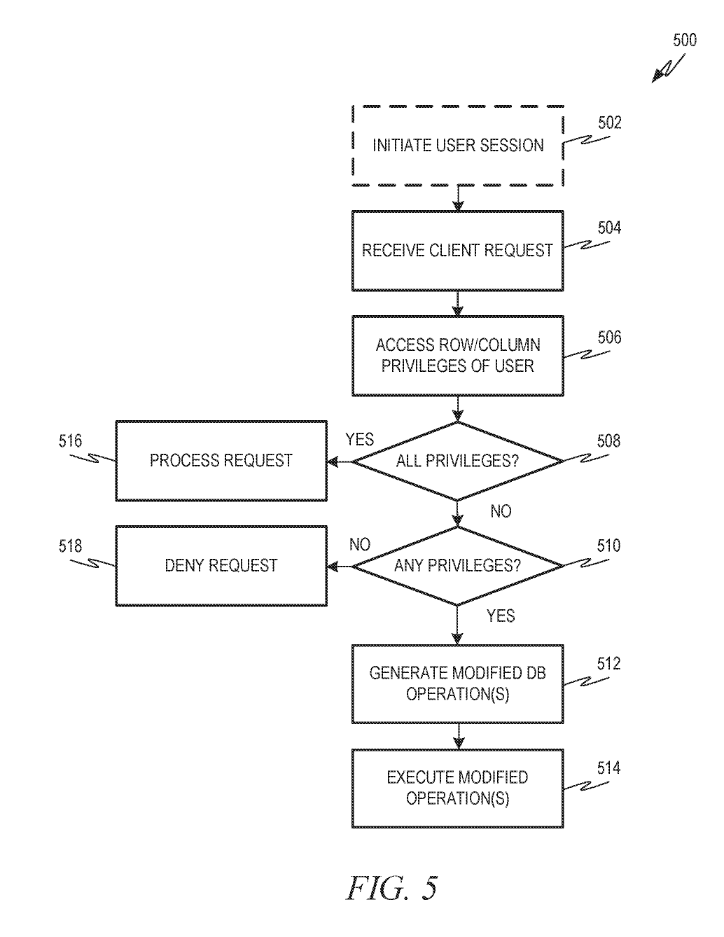

FIG. 5 is a flow chart showing one example of a process flow 500 that may be executed by a database management system to process a client request. The process flow 500 may be executed by any suitable database management system including, for example, the database management system 102 and/or database management system 200 described herein. Optionally, at operation 502, the database management system may initiate a user session. Initiating a user session may include receiving log-in data from a client application. As described herein, the client application may itself be the user or may provide log-in data on behalf of a human or other user. In some examples, the database management system may include a session management component 300 to receive log-in data and initiate a user session, for example, as described herein. Also, in some examples, operation 502 may be omitted. Instead, the client application may provide log-in information concurrent with a client request.

At operation 504, the database may receive a client request. The client request may describe one or more database operations to be performed at the database. The database operations may be expressed in any suitable language or syntax including, for example, SQL or any other suitable syntax. In some examples, the client request may also include log-in information. The database management system may utilize the log-in information to authenticate the user associated with the client request.

At operation 506, the database management system (e.g., a privilege filter thereof) may access row and/or column privileges of the user. For example, the privilege filter may query a privilege table to receive a privilege record or records of the user. At operation 508, the privilege filter may determine whether the user has privileges to perform the database operation or operations indicated by the client request. For example, the privilege filter may determine which database table rows and/or columns are acted upon by the requested database operation or operations and in what way. The privilege filter may compare these to the user's privileges. If the user has all of the privileges necessary to execute the database operation or operations, the database management system may process the client request at operation 516, for example, by executing the indicated database operations.

If the user does not have all of the privileges necessary to execute the requested database operation or operations, then the privilege filter may, at operation 510. determine whether the user has any of the privileges necessary to execute the requested database operation or operations. If the user lacks all privileges necessary to execute the requested database operation or operations, the database management system may deny the client request at operation 518. For example, the database management system may send a message to the client application indicating that the client request has been denied.

If the user has some of the privileges for executing the requested database operation or operations, the privilege filter may, at operation 512, generate a modified database operation or operations that operate only on rows and/or columns for which the user possesses sufficient privileges. At operation 514, the database management system may execute the modified database operation or operations.

For example, consider a database table t1 that includes columns c1, c2, and c3, as defined by the pseudocode segment below:

create table t1 (c1 int, c2 int, c3 varchar (256))

As indicated, record fields in columns c1 and c2 may include integer data while record fields in column c3 may include a character having up to 256 bits. Consider a user, user 1 that is to be permitted only to select or update columns c1 and c2 with values greater than 10 and is to be permitted to insert or delete only rows with c2 values greater than 20. Pseudocode demonstrating a request to implement that example permission for SELECT, UPDATE, INSERT, and DELETE database operations is provided below:

grant select on t1 (c1, c2) where c1 > 10 to user1
grant update on t1 (c1, c2) where c1 > 10 to user1
grant insert on t1 where c2 > 20 to user1
grant delete on t1 where c2 > 20 to user1

The user1 may submit a client request indicating the following database operation:

select c1, c2 from t1

In this example, the privilege filter may generate a modified database operation that returns record fields in columns c1 and c2, but only for records where the value of the record field in column c1 is greater than 10.
In another example, user 1 may request the following database operation

update t1 set c2=c2+2 where c2>20

In this example, the privilege filter may generate a modified database operation (operation 512) that increments record fields in column c2 by two, but only those record fields in column c2 that are part of records where the record field in column c1 is greater than 10 and the record field in column c2 is greater than 20.

In another example, user1 may request the following database operation.

insert into t1 values (1,1,‘abc’)

In this example, the client request (or the portion of the client request including the above database operation) may be dened (operation 516). For example, recall that user1 has privileges to execute insert database operations only on records where the record field in column c2 is greater than 20. In the example above, the record field at column c2 is 1, which is not greater than 20.

In yet another example, user 1 may request the following database operation:

delete from t1 where c1=5

In this example, the privilege filter may generate a modified database operation (operation 512) that deletes only records having record fields in c1 with values that are equal to 5 and having record fields in column c2 with values greater than 20.

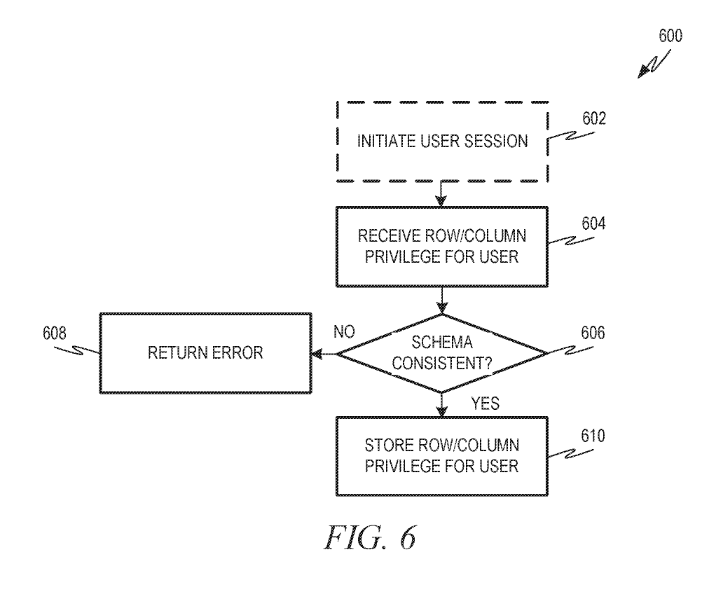

FIG. 6 is a flowchart showing one example of a process flow 600 that may be executed by a database management system to set or change a user privilege with respect to a row and/or column. The process flow 600 may be executed by any suitable database management system including, for example, database management system 102 and/or database management system 200 described herein. Optionally, at operation 602, the database management system may initiate a user session, for example, as described herein with respect to operation 502. Alternatively (or additionally) a request to change or set user privileges may include log-in information. In some examples, the database management system may permit only a limited number of users (e.g.. administrative users) to modify user row and/or column privileges. Also, in sonic examples, the client requests to modify user privileges (e.g., by modifying the privilege table) may be subject to the same row and/or column-specific user privileges as other database tables. That is, different users may have different privileges to modify or otherwise perform operations on the privilege table.

At operation 604, the database management system may receive a client request including privilege data describing a change to user privileges. IN The privilege data may indicating a change to a row and/or column privilege for a user. In some examples, the privilege data may identify a database operation acting on the privilege table and user data describing the user (e.g., privilege table record) for the change. The database operation may reference one or more users and may add, delete, and/or modify a user privilege with respect to a row or column. In some examples, the client request may express the privilege change in Data Control Language (DCL). An example DCL code segment for granting privileges is provided below:

grant <privilege> on <table_name>
[<column_list_clause>] <where_clause> to <grantee>
<privilege> ::= SELECT | UPDATE | INSERT | DELETE
<column_list_clause> ::= ( <column_name>, ...)
<where_clause> ::= where <condition>

In example code segment, an indicated privilege, <privilege>, is granted to a user, <grantee>. Here, the privilege grants the user, <grantee>, permission to execute SELECT, UPDATE, INSERT, and DELETE database operations on the indicated columns. The columns are indicated as an array of column names referred to as <column_list_clause>. In the example code segment, the <where clause> may indicate a condition on the privilege. Any suitable condition may be used. Some example conditions are based on the content of a record. For example, a user may be permitted to modify record fields in a particular row, but only for records having a certain value or range of values at another record field. Additional pseudocode examples for granting user privileges are provided herein above at paragraph [0049].

Optionally, at operation 606, the database management system (e.g., the privilege filter) may determine whether the requested privilege changes are consistent with the database schema. For example, the database management system (e.g., the privilege filter) may ensure that all database table rows and/or columns referenced by the received change are present in the database. If not, then the database management system may return an error at operation 608. If the requested change is consistent with the database schema and/or operation 606 is omitted, the database management system (e.g., the privilege filter) may store the requested privileged change at the privileged table at operation 610.

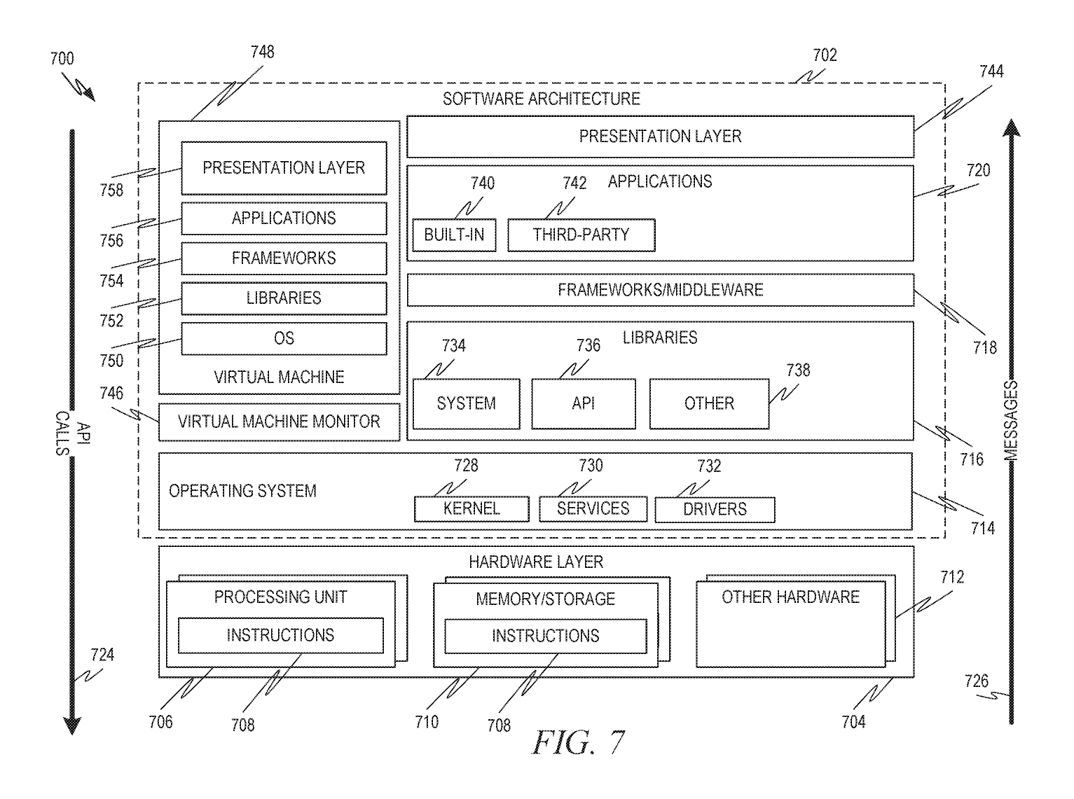

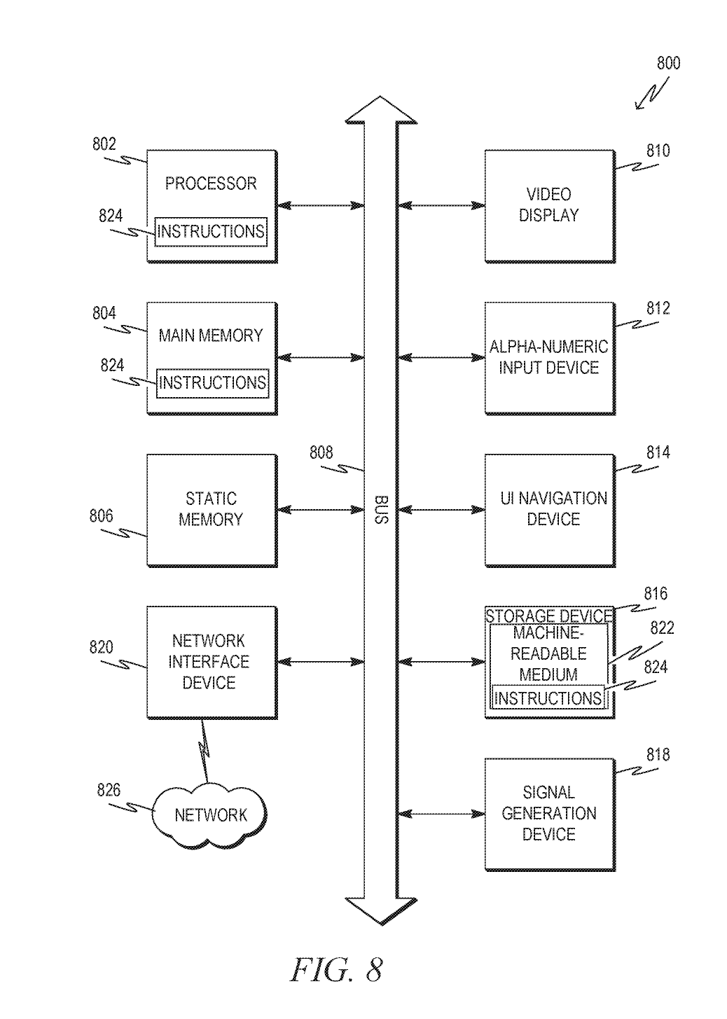

FIG. 7 is a block diagram 700 showing one example of a software architecture 702 for a computing device. The architecture 702 may be used in conjunction with various hardware architectures, for example, as described herein. FIG. 7 is merely a non-limiting example of a software architecture and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system 800 of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 which represents any other hardware of the hardware layer 704, such as the other hardware illustrated as part of computer system 800.

In the example architecture of FIG. 7, the software architecture 702 may be conceptualized as a stack of layers where each layer provides particular functionality. For example, the software architecture 702 may include layers such as an operating system 714, libraries 716, frameworks/middleware 718, applications 720 and presentation layer 744. Operationally, the applications 720 and/or other components within the layers may invoke application programming interface (API) calls 724 through the software stack and access a response, returned values, and so forth illustrated as messages 726 in response to the API calls 724. The layers illustrated are representative in nature and not all software architectures have all layers. For example, some mobile or special purpose operating systems may not provide a frameworks/middleware layer 718, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers, In some examples, the services 730 include an interrupt service. The interrupt service may detect the receipt of an interrupt and, in response, cause the architecture 702 to pause its current processing and execute an interrupt service routine (ISR) when an interrupt is accessed.

The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 and/or other software components/modules. For example, the frameworks 718 may provide various graphic user interface (GUI) functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 includes built-in applications 740 and/or third party applications 742. Examples of representative built-in applications 740 may include, but are not limited to, a contacts application, a browser application, a book reader application, a location application, a media application, a messaging application, and/or a game application. Third party applications 742 may include any of the built in applications as well as a broad assortment of other applications. In a specific example, the third party application 742 (e.g., an application developed using the Android™ or iOS™ software development kit (SDK) by an entity other than the vendor of the particular platform) may be mobile software running on a mobile operating system such as iOS™, Android™. Windows® Phone, or other mobile computing device operating systems. In this example, the third party application 742 may invoke the API calls 724 provided by the mobile operating system such as operating system 714 to facilitate functionality described herein.

The applications 720 may utilize built in operating system functions kernel 728, services 730 and/or drivers 732), libraries e.g., system 734, APIs 736, and other libraries 738), frameworks / middleware 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a. memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a. programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface (UI) navigation (or cursor control) device 814 (e.g., a mouse), a disk drive unit 816, a signal generation device 818 (e.g., a speaker and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802. during execution thereof by the computer system 800, with the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLES

Example 1 is a database management system, comprising: at least one processor and a memory in communication with the at least one processor, wherein the at least one processor is programmed to perform operations comprising: receiving a first client request, wherein the first client request describes a first database operation on a first record from a first table of a database, wherein the first table comprises a plurality of columns, wherein a first record field of the first record is in a first column of the plurality of columns, and wherein a second record field of the first record is in a second column of the plurality of columns; determining that a user associated with the first client request lacks privileges to perform the first database operation on record fields in the first column; generating a modified first database operation that does not perform the first database operation on the first record field of the first record; and executing the modified first database operation at the database.

In Example 2, the subject matter of Example 1 optionally includes wherein the first database operation is also on a second record from the first table, and wherein the at least one processor is further programmed to perform operations comprising: determining that the user lacks privileges to perform the first database operation on the second record, wherein the modified first database operation does not perform the first database operation on the second record.

In Example 3, the subject matter of any one or more of Examples 1-2 optionally includes wherein the first database operation is also on a second record from the first table, wherein the second record comprises a first record field of the second record that is in the first column and a second record field of the second record that is in the second column, and wherein the modified first database operation does not perform the first database operation on the first record field of the first column.

In Example 4, the subject matter of any one or more of Examples 1-3 optionally includes wherein determining that the user lacks privileges to perform the first database operation on record fields under the first column comprises querying a privilege table for a first privilege table record corresponding the user, wherein the first privilege table record indicates that the user lacks privileges to perform the first database operation on record fields under the first column.

In Example 5, the subject matter of any one or more of Examples 1-4 optionally includes wherein determining that the user lacks privileges to perform the first database operation on record fields under the first column comprises querying a privilege table for a first privilege table record corresponding to the user, wherein the first privilege table record indicates a set of columns from the first table and at least one operation that the user is permitted to perform on records in the set of columns.

In Example 6, the subject matter of any one or more of Examples 1-5 optionally includes wherein the first database operation is selected from the group consisting of reading the first record or writing to the first record.

In Example 7, the subject matter of any one or more of Examples 1-6 optionally includes wherein the at least one processor is further programmed to perform operations comprising: receiving from an administrative user a client request comprising user data describing the user and privilege data indicating that the user is to have privileges to perform the first database operation on record fields in the first column; and writing, to a first privilege table record of the user, an indication that the user has privileges to operate on record fields in the first column.

In Example 8, the subject matter of any one or more of Examples 1-7 optionally includes wherein determining that the user lacks privileges to perform the first database operation on record fields in the first column comprises: determining that a value of the second record field of the first record meets a first condition; and determining that the user is not permitted perform the first database operation on the first record field of the first record when the second record field of the first record meets the first condition.

Example 9 is a method, comprising: receiving, by a database management system, a first client request, wherein the first client request describes a first database operation on a first record from a first table of a database, wherein the first table comprises a plurality of columns, wherein a first record field of the first record is in a first column of the plurality of columns, wherein a second record field of the first record is in a second column of the plurality of columns, and wherein the database management system comprises at least one processor and a memory in communication with the at least one processor; determining, by the database management system, that a user associated with the first client request lacks privileges to perform the first database operation on record fields in the first column; generating, by the database management system, a modified first database operation that does not perform the first database operation on the first record field of the first record; and executing, by the database management system, the modified first database operation at the database.

In Example 10, the subject matter of Example 9 optionally includes wherein the first database operation is also on a second record from the first table, further comprising: determining, by the database management system, that the user lacks privileges to perform the first database operation on the second record, wherein the modified first database operation does not perform the first database operation on the second record.

In Example 11, the subject matter of any one or more of Examples 9-10 optionally includes wherein the first database operation is also on a second record from the first table, wherein the second record comprises a first record field of the second record that is in the first column and a second record field of the second record that is in the second column, and wherein the modified first database operation does not perform the first database operation on the first record field of the first column.

In Example 12, the subject matter of any one or more of Examples 9-11 optionally includes wherein determining that the user lacks privileges to perform the first database operation on record fields under the first column comprises querying a privilege table for a first privilege table record corresponding the user, wherein the first privilege table record indicates that the user lacks privileges to perform the first database operation on record fields under the first column.

In Example 13, the subject matter of any one or more of Examples 9-12 optionally includes wherein determining that the user lacks privileges to perform the first database operation on record fields under the first column comprises querying a privilege table for a first privilege table record corresponding to the user, wherein the first privilege table record indicates a set of columns from the first table and at least one operation that the user is permitted to perform on records in the set of columns.

In Example 14, the subject matter of any one or more of Examples 9-13 optionally includes wherein the first database operation is selected from the group consisting of reading the first record or writing to the first record.

In Example 15, the subject matter of any one or more of Examples 9-14 optionally includes receiving, by the database management system and from an administrative user a client request comprising user data describing the user and privilege data indicating that the user is to have privileges to perform the first database operation on record fields in the first column; and writing, by the database management system and to a first privilege table record of the user, an indication that the user has privileges to operate on record fields in the first column.

In Example 16, the subject matter of any one or more of Examples 9-15 optionally includes wherein determining that the user lacks privileges to perform the first database operation on record fields in the first column comprises: determining that a value of the second record field of the first record meets a first condition; and determining that the user is not permitted perform the first database operation on the first record field of the first record when the second record field of the first record meets the first condition.

Example 17 is at least one machine readable medium comprising instructions thereon that, when executed by at least one processor, causes the at least one processor to perform operations comprising: receiving a first client request, wherein the first client request describes a first database operation on a first record from a first table of a database, wherein the first table comprises a plurality of columns, wherein a first record field of the first record is in a first column of the plurality of columns, and wherein a second record field of the first record is in a second column of the plurality of columns; determining that a user associated with the first client request lacks privileges to perform the first database operation on record fields in the first column; generating a modified first database operation that does not perform the first database operation on the first record field of the first record; and executing the modified first database operation at the database.

In Example 18, the subject matter of Example 17 optionally includes wherein the first database operation is also on a second record from the first table, further comprising: determining that the user lacks privileges to perform the first database operation on the second record, wherein the modified first database operation does not perform the first database operation on the second record.

In Example 19, the subject matter of any one or more of Examples 17-18 optionally includes wherein the first database operation is also on a second record from the first table, wherein the second record comprises a first record field of the second record that is in the first column and a second record field of the second record that is in the second column, and wherein the modified first database operation does not perform the first database operation on the first record field of the first column.

In Example 20, the subject matter of any one or more of Examples 17-19 optionally includes instructions thereon that, when executed by at least one processor, causes the at least one processor to perform operations comprising: receiving from an administrative user a client request comprising user data describing the user and privilege data indicating that the user is to have privileges to perform the first database operation on record fields in the first column; and writing, to a first privilege table record of the user, an indication that the user has privileges to operate on record fields in the first column.

What is claimed is:

1. A database management system, comprising:
at least one processor and a memory in communication with the at least one processor, wherein the at least one processor is programmed to perform operations comprising:
receiving a first client request, wherein the first client request describes a first database operation on a first record from a first table of a database, wherein the first table comprises a plurality of columns, wherein a first record field of the first record is in a first column of the plurality of columns, and wherein a second record field of the first record is in a second column of the plurality of columns;
determining that a user associated with the first client request lacks privileges to perform the first database operation on record fields in the first column;
generating a modified first database operation that does not perform the first database operation on the first record field of the first record; and
executing the modified first database operation at the database.

2. The database management system of claim 1, wherein the first database operation is also on a second record from the first table, and wherein the at least one processor is further programmed to perform operations comprising:
determining that the user lacks privileges to perform the first database operation on the second record, wherein the modified first database operation does not perform the first database operation on the second record.

3. The database management system of claim 1, wherein the first database operation is also on a second record from the first table, wherein the second record comprises a first record field of the second record that is in the first column and a second record field of the second record that is in the second column, and wherein the modified first database operation does not perform the first database operation on the first record field of the first column.

4. The database management system of claim 1, wherein determining that the user lacks privileges to perform the first database operation on record fields under the first column comprises querying a privilege table for a first privilege table record corresponding the user, wherein the first privilege table record indicates that the user lacks privileges to perform the first database operation on record fields under the first column.

5. The database management system of claim 1, wherein determining that the user lacks privileges to perform the first database operation on record fields under the first column comprises querying a privilege table for a first privilege table record corresponding to the user, wherein the first privilege table record indicates a set of columns from the first table and at least one operation that the user is permitted to perform on records in the set of columns.

6. The database management system of claim 1, wherein the first database operation is selected from the group consisting of reading the first record or writing to the first record.

7. The database management system of claim 1, wherein the at least one processor is further programmed to perform operations comprising:
receiving from an administrative user a client request comprising user data describing the user and privilege data indicating that the user is to have privileges to perform the first database operation on record fields in the first column; and
writing, to a first privilege e record of the user, an indication that the user has privileges to operate on record fields in the first column.

8. The database management system of claim 1, wherein determining that the user lacks privileges to perform the first database operation on record fields in the first column comprises:
determining that a value of the second record field of the first record meets a first condition; and
determining that the user is not permitted perform the first database operation on the first record field of the first record when the second record field of the first record meets the first condition.

9. A method, comprising:
receiving, by a database management system, a first client request, wherein the first client request describes a first database operation on a first record from a first table of a database, wherein the first table comprises a plurality of columns, wherein a first record field of the first record is in a first column of the plurality of columns, wherein a second record field of the first record is in a second column of the plurality of columns, and wherein the database management system comprises at least one processor and a memory in communication with the at least one processor;
determining, by the database management system, that a user associated with the first client request lacks privileges to perform the first database operation on record fields in the first column;
generating, by the database management system, a modified first database operation that does not perform the first database operation on the first record field of the first record; and
executing, by the database management system, the modified first database operation at the database.

10. The method of claim 9, wherein the first database operation is also on a second record from the first table, further comprising:
determining, by the database management system, that the user lacks privileges to perform the first database operation on the second record, wherein the modified first database operation does not perform the first database operation on the second record.

11. The method of claim 9, wherein the first database operation is also on a second record from the first table, wherein the second record comprises a first record field of the second record that is in the first column and a second record field of the second record that is in the second column, and wherein the modified first database operation does not perform the first database operation on the first record field of the first column.

12. The method of claim 9, wherein determining that the user lacks privileges to perform the first database operation on record fields under the first column comprises querying a privilege table for a first privilege table record corresponding the user, wherein the first privilege table record indicates that the user lacks privileges to perform the first database operation on record fields under the first column.

13. The method of claim 9, wherein determining that the user lacks privileges to perform the first database operation on record fields under the first column comprises querying a privilege table for a first privilege table record corresponding to the user, wherein the first privilege table record indicates a set of columns from the first table and at least one operation that the user is permitted to perform on records in the set of columns.

14. The method of claim 9, wherein the first database operation is selected from the group consisting of reading the first record or writing to the first record.

15. The method of claim 9, further comprising:
receiving, by the database management system and from an administrative user a client request comprising user data describing the user and privilege data indicating that the user is to have privileges to perform the first database operation on record fields in the first column; and
writing, by the database management system and to a first privilege table record of the user, an indication that the user has privileges to operate on record fields in the first column.

16. The method of claim 9, wherein determining that the user lacks privileges to perform the first database operation on record fields in the first column comprises:
determining that a value of the second record field of the first record meets a first condition; and
determining that the user is not permitted perform the first database operation on the first record field of the first record when the second record field of the first record meets the first condition.

17. At least one machine readable medium comprising instructions thereon that, when executed by at least one processor, causes the at least one processor to perform operations comprising:
receiving a first client request, wherein the first client request describes a first database operation on a first record from a first table of a database, wherein the first table comprises a plurality of columns, wherein a first record field of the first record is in a first column of the plurality of columns, and wherein a second record field of the first record is in a second column of the plurality of columns;
determining that a user associated with the first client request lacks privileges to perform the first database operation on record fields in the first column;
generating a modified first database operation that does not perform the first database operation on the first record field of the first record; and
executing the modified first database operation at the database.

18. The at least one machine readable medium of claim 17, wherein the first database operation is also on a second record from the first table, further comprising:
determining that the user lacks privileges to perform the first database operation on the second record, wherein the modified first database operation does not perform the first database operation on the second record.

19. The at least one machine readable medium of claim 17, wherein the first database operation is also on a second record from the first table, wherein the second record comprises a first record field of the second record that is in the first column and a second record field of the second record that is in the second column, and wherein the modified first database operation does not perform the first database operation on the first record field of the first column.

20. The at least one machine readable medium of claim 17, further comprising instructions thereon that, when executed by at least one processor, causes the at least one processor to perform operations comprising:
receiving from an administrative user a client request comprising user data describing the user and privilege data indicating that the user is to have privileges to perform the first database operation on record fields in the first column; and
writing, to a first privilege table record of the user, an indication that the user has privileges to operate on record fields in the first column.
